(19) United States
(12) Patent Application Publication
(10) Pub. No.: US 2006/0082659 A1
(43) Pub. Date: Apr. 20, 2006

(54) Optical image stabilizer for camera lens assembly

(75) Inventor: Jun-Mo Koo, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/063,097

(22) Filed: Feb. 22, 2005

(30) Foreign Application Priority Data
Oct. 20, 2004 (KR) 2004-83900

(51) Int. Cl. H04N 5/228

(52) U.S. Cl. 348/208.99

(57) ABSTRACT

An optical image stabilizer for a camera lens assembly is disclosed and includes: a board having an image sensor on one surface thereof; a double actuator disposed at one side of the board for moving the board in a first direction and a second direction perpendicular to the first direction on a plane; and a guide means for guiding the movements of the board in the first and the second directions, while preventing the board from rotating about an optical axis of the camera lens assembly. The double actuator for moving the board in two directions is disposed at only one side of the board, so that the camera lens assembly including the optical image stabilizer can be downsized. Further, the guide means permits the board to move only linearly in the first direction and the second direction, thereby preventing the image sensor from rotating around an optical axis and thus improving the reliability of the camera lens assembly.

### CLAIM OF PRIORITY

This application claims priority to an application entitled “Optical Image Stabilizer for Camera Lens Assembly,” filed in the Korean Intellectual Property Office on Oct. 20, 2004 and assigned Serial No. 2004-83900, the contents of which are hereby incorporated by reference.

### BACKGROUND OF THE INVENTION

1. Field of the Invention

The present invention relates to a camera device and, more particularly, to an optical image stabilizer used in a camera lens assembly.

2. Description of the Related Art

Currently, there are two types of two-dimensional sensors available: a CCD (Chare Coupled Device) sensor and a CMOS (Complementary Metal Oxide Semiconductor) sensor. These sensors are used in cameras for photographing dynamic and static images. The CCD sensors are superior to the CMOS sensors in image quality. However, the CCD sensors have the drawback of requiring high-power consumption and complicated structures. As a result, the demand for CMOS image sensors has increased in the market.

Recently, many efforts are being made to improve the image quality of CMOS sensors. The development in image sensors has contributed to a mass production of portable terminals, such as cellular phones equipped with camera devices.

When users take photographs with conventional cameras for photographing static images and moving images using the above-mentioned image sensors, unstable images are frequently captured due to shaking cameras resulting from external causes, such as the user's trembling hands or the mounting of cameras on vehicles. In order to solve the problem of unstable images, optical image stabilizers have been suggested. The optical image stabilizers typically include a movement-detector portion and a movement-compensator portion.

For the movement detector, available is a method of predicting the movements of a device used by a Gyro Sensor, etc., as well as a method of detecting the moved portion of an image in every frame by processing image signals. Utilizing a refraction lens (active prism) optionally refracting the incident light or controlling the input position of an image sensor are common techniques used to improve unstable images. U.S. Pat. No. 5,398,132 (published on Mar. 14, 1995) discloses an optical image stabilizer, wherein a lens is driven by using a voice coil motor for the purpose of solving the problem of unstable images resulting from movements of a camera. The optical image stabilizer disclosed therein includes a pitch coil and a pitch yoke disposed on one end of a compensator lens for driving the compensator lens in a first direction as well as a yaw coil, and a yaw yoke disposed on the other side of the compensator lens for driving the compensator lens in a second direction perpendicular to the first direction.

Portable terminals tend to have extended functions due to a camera device mounted on portable terminals such as laptop computers and portable phones. However, the conventional optical image stabilizers hinder the portable terminals from being downsized and lightened. Therefore, there is a need to provide an improved optical image stabilizer that can be used in portable terminals.

### SUMMARY OF THE INVENTION

The present invention relates to an optical image stabilizer for a camera lens assembly, which facilitates downsizing and lightening of the camera lens assembly.

One aspect of the present invention is to provide an optical image stabilizer used in a camera lens assembly that is capable of providing a low driving resistance when a lens or image sensor is driven and preventing unwanted rotation of a lens or image sensor.

Another aspect of the present invention is to provide an optical image stabilizer including: a board having an image sensor on one surface thereof; a double actuator disposed at one side of the board for moving the board in a first direction and a second direction perpendicular to the first direction on a plane; and a guide means for guiding the movements of the board in the first and the second directions, while preventing the board from rotating around an optical axis of the camera lens assembly.

### BRIEF DESCRIPTION OF THE DRAWINGS

The above features and advantages of the present invention will be more apparent from the following detailed description taken in conjunction with the accompanying drawings, in which:

FIG. 1 shows the structure of a camera lens assembly equipped with an optical image stabilizer according to an embodiment of the present invention; FIGS. 2a and 2b are perspective views each showing the optical image stabilizer included in the camera lens assembly shown in FIG. 1;

FIG. 3 is a lateral side view showing the optical image stabilizer shown in each of FIGS. 2a and 2b after the assemblage; and

FIG. 4 is an exploded perspective view of the guide means included in the optical image stabilizer shown in each of FIGS. 2a and 2b.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

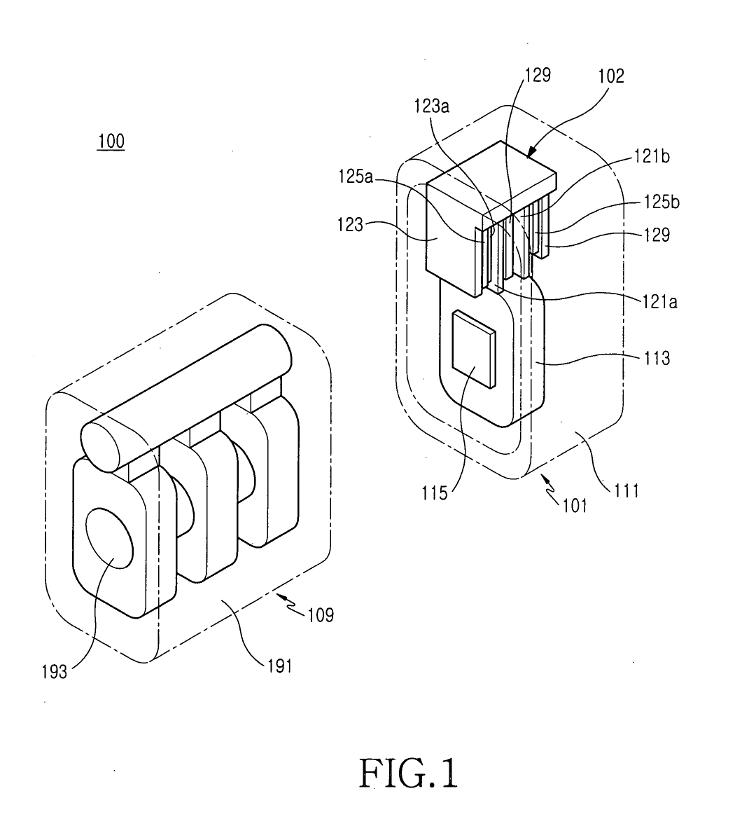

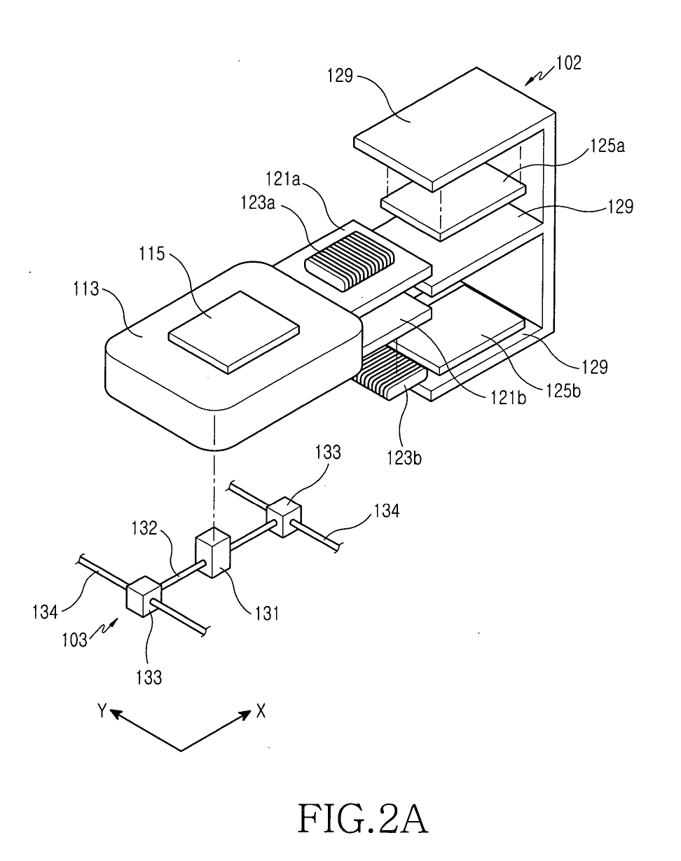

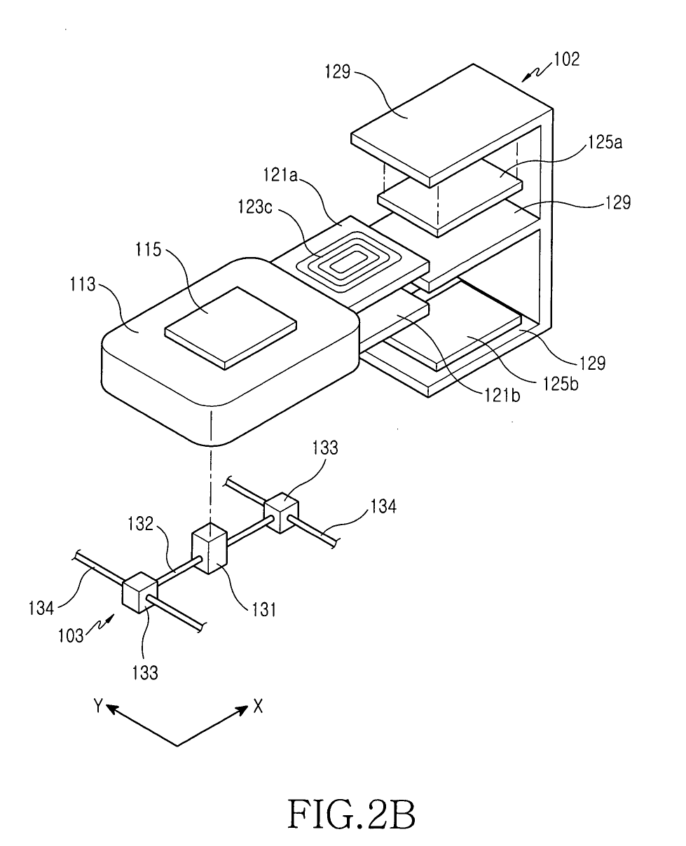

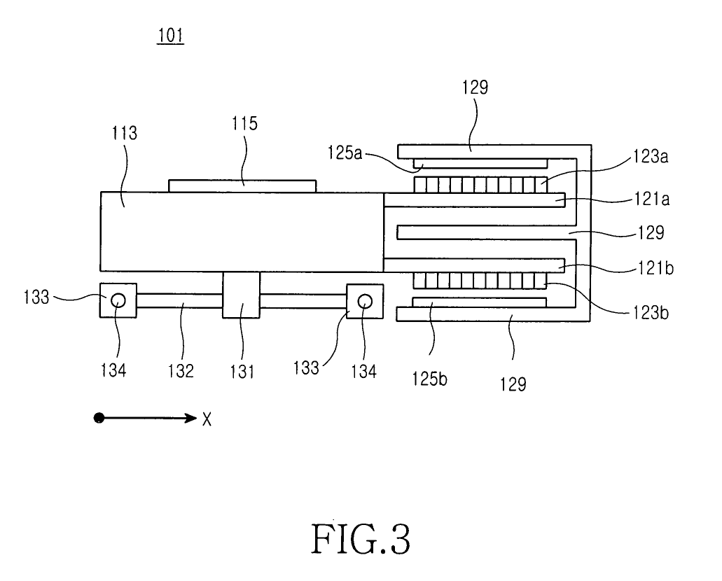

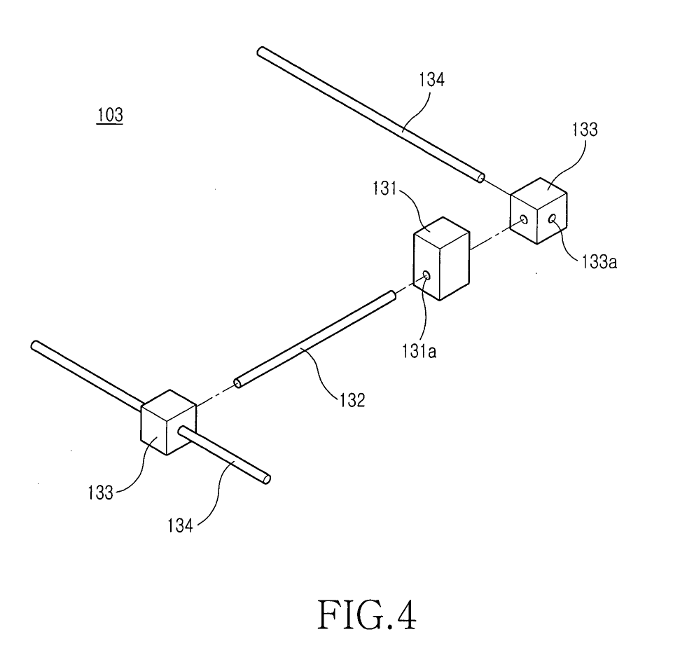

Referring to FIGS. 1 to 3, an optical image stabilizer according to an embodiment of the present invention includes a board 113, a double actuator 102 and a guide means 103. The optical image stabilizer is disposed in a module housing 111 to form a single sensor assembly 101.

The sensor assembly 101 forms a camera lens assembly 100 together with a lens assembly 109 including an optical tube structure 191 in which at least one lens 193 is disposed.

The board 113 has an image sensor 115 on one surface thereof and moves in the module housing 111 by the driving force of the double actuator 102, wherein the movements of the board 113 are guided by the guide means 103. More particularly, the double actuator 102 drives the board 113 when a movement of the camera lens assembly 100 is detected by a Gyro sensor (not shown), etc.

The double actuator 102 includes a first and a second support plates 121a, 121b, a first and a second coils (123a, 123b), and a first and a second magnetic bodies 125a, 125b. The first and the second support plates 121a, 121b, facing each other, extend from one lateral surface of the board 113, thereby providing a plane perpendicular to the optical axis of the image sensor 115. That is, at least one surface of the first and the second support plates 121a, 121b faces the same direction as the image sensor 115.

The first support plate 121a extends from one lateral surface of the board 113 and at the top thereof. A first coil 123a is disposed on one surface of the first support plate 121a. Therefore, the first coil 123a may be disposed in parallel with the image sensor 115.

The second support plate 121b extends from one surface of the board 113 and at the bottom thereof. A second coil 123b is disposed on one surface of the second support plate 121b. That is, the first and the second coils 123a, 123b are disposed on two surfaces facing each other. More particularly, the first coil 123a and the second coil 123b are disposed on the first support plate 121a and the second support plate 121b, respectively, in such a manner that the winding directions of copper wires in both coils are perpendicular to each other. Alternatively, as shown in FIG. 2b, the first and the second coils 123c (only the first coil is shown) may be disposed on the first and the second support plates 121a, 121b, respectively, in the form of a printed circuit having a spiral pattern.

The first and the second magnetic bodies 125a, 125b are disposed in such a manner that they face the first coil 123a and the second coil 123b, respectively, each magnetic body and each coil being spaced apart from each other. Because the first and the second coils 123a, 123b face the first and the second magnetic bodies 125a, 125b, respectively, it is possible to generate a magnetic field when electric currents are applied to the first and the second coils 123a, 123b. The magnetic field generated cooperates with the magnetic field resulting from the first and the second magnetic bodies 125a, 125b, thereby forming a voice coil motor for driving the board 113. The voice coil motors or actuators are very durable, fast and provide high performance due to fewer parts that are subject to daily stress and wear. The term, “voice coil” is originated from a conventional speaker in which a part of a speaker consists of a small coil of wire positioned next to a permanent magnetic filed, such that when an electric current is fed into the voice coil, the coil will either move forward or backward due to its interaction with the magnetic field.

In order to mount the first and the second magnetic bodies 125a, 125b, the double actuator 102 is provided with at least one pair of yokes 129. If desired, the double actuator 102 may be further provided with a yoke interposed between the first support plate 121a and the second support plate 121b. Each of the yokes 129 is disposed to face the first or the second support plate 121a, 121b, and each of the first and the second magnetic bodies 125a, 125b is disposed on the inner surface of each yoke 129. Accordingly, the first and the second magnetic bodies 125a, 125b are facing the first and the second coils 123a, 123b, respectively.

When a driving force is generated by the application of electric currents to the first coil 123a of the double actuator 102, the driving force moves the board 113 in the first direction X. On the other hand, when a driving force is generated by the application of electric currents to the second coil 123b of the double actuator 102, the driving force moves the board 113 in the second direction Y, which is perpendicular to the first direction X. Further, when a driving force is generated by the co-application of electric currents to the first coil 123a and the second coil 123b of the double actuator 102, the driving force moves the board 113 in a diagonal direction inclined to the first direction X or the second direction Y. That is, when currents are applied to both coils, the board moves, in turn, x-direction and y-direction.

The guide means 103 is disposed on the other surface of the board 113 to guide the movements of the board 103 depending on the operation of the double actuator 102, while stabilizing the position of the board 113 in the module housing 111.

The guide means 103 includes a first slider 131, a first guide shaft 132, a pair of second sliders 133, and a pair of second guide shafts 134.

The first slider 131 is fixed to the other surface of the board 113 and has an opening hole 131a extending in the first direction X. Although the first slider 131 shown in the accompanying drawings has a general cubic shape, it may take the form of a truncated pyramid by enlarging the top surface thereof or may have a support piece, so as to be attached firmly to the board 113.

The first guide shaft 132 extends in the first direction X and is coupled slidably to the opening 131a of the first slider 131. As a result, the first slider 131 slides on the first guide shaft 132 in the first direction X, while guiding the movement of the board 113 in the first direction X according to the motions of the double actuator 102.

The second sliders 133 are fixed to both ends of the first guide shaft 132, and each slider 133 has a through hole 133a extending in the second direction Y.

Each of the second shafts 134 extends in the second direction Y and is coupled slidably to the opening 133a of the second slider 133. As a result, each second slider 133 slides on the second guide shaft 134 in the second direction Y, while guiding the movement of the board 113 in the second direction Y according to the motions of the double actuator 102. Meanwhile, although not shown in the accompanying drawings, both ends of each guide shaft 134 are fixed to the inner surface of the module housing 111.

The guide means 103 as described above guide the board 113 moving in the first X or the second direction Y as the double actuator 102 drives. Particularly, the first slider 131 can slide only in the first direction X, while the second sliders 133 can slide only in the second direction Y. Additionally, since the board 113 moves in the presence of the guidance by the first and the second sliders 131, 133 according to the motions of the double actuator 102, the motions of the board 113 are limited to linear motions only. More specifically, it is not possible to rotate the board 113 around the optical axis formed on the lens 193 and the image sensor 115.

Accordingly, the guide means 103 facilitates movement of the board 113 in the first and the second directions X, Y, while preventing the image sensor 115 from rotating about the optical axis, resulting in optical image stabilization of the camera lens assembly 100.

As it can be seen from the foregoing, an optical image stabilizer according to the present invention includes a double actuator disposed at one side of a board having an image sensor so that the board can move in a first direction and in a second direction perpendicular to the first direction. Particularly, because the double actuator for moving the board in two directions is disposed at only one side of the board, it is possible to downsize a camera lens assembly including the optical image stabilizer. Further, because a guide means permits the board to move only linearly along the first direction and the second direction, the guide means can prevent the image sensor from rotating around an optical axis, while facilitating the movements of the board, thereby improving the reliability of the camera lens assembly.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical image stabilizer for a camera lens assembly, comprising:
a board having an image sensor on one surface thereof;
a double actuator disposed at one end of the board for moving the board in a first direction and a second direction; and
a guide means for guiding the movements of the board in the first and the second directions, while preventing the board from rotating about an optical axis of the camera lens assembly.

2. The optical image stabilizer as claimed in claim 1, wherein the double actuator includes:
a first support plate and a second support plate facing each other, each extending from one lateral surface of the board to provide a plane perpendicular to the optical axis;
a first coil and a second coil disposed on a surface of the first support plate and a surface of the second support plate, both surfaces facing each other; and
a first magnetic body and a second magnetic body facing the first coil and the second coil, respectively, each magnetic body and each coil being spaced apart from each other,
wherein the first and the second coils generate a driving force for moving the board when electric currents are applied thereto.

3. The optical image stabilizer as claimed in claim 2, wherein the board moves in the first direction when electric currents are applied to the first coil, and the board moves in the second direction when electric currents are applied to the second coil.

4. The optical image stabilizer as claimed in claim 2, further including a pair of yokes to which each of the first and the second magnetic bodies is attached.

5. The optical image stabilizer as claimed in claim 2, further including a yoke interposed between the first support plate and the second support plate.

6. The optical image stabilizer as claimed in claim 1, wherein the guide means includes:
a first slider fixed to the other surface of the board and having an opening extending in the first direction;
a first guide shaft extending in the first direction and slidably coupled to the opening of the first slider;
a pair of second sliders fixed to both ends of the first guide shaft, each having an opening extending in the second direction; and
a pair of second guide shafts extending in the second direction, each slidably coupled to the opening of the second slider.

7. The optical image stabilizer as claimed in claim 1, wherein the optical lens stabilizer is adaptable to a lens assembly having at least one lens.

8. The optical image stabilizer as claimed in claim 1, wherein the first direction is substantially perpendicular to the second direction.

9. The optical image stabilizer as claimed in claim 1, wherein the double actuator drives the board when a movement of the camera lens assembly is detected.

10. An optical image stabilizer for a camera lens assembly, comprising:
a housing;
a board having a first board plate and a second board plate, the first board plate having a first coil and the second board plate having a second coil; and
an actuator for moving the board to a first direction and a second direction,
wherein the movement of the board is generated by an application of electric currents to the first coil and the second coil.

11. The optical image stabilizer as claimed in claim 10, wherein the actuator further comprising a first and a second magnetic body disposed in such a manner that they face the first coil and the second coil, respectively.

12. The optical image stabilizer as claimed in claim 10, wherein the board moves diagonally with respect to the first direction or the second direction if electric currents are applied to both the first and the second coils.

13. The optical image stabilizer as claimed in claim 10, wherein the boarding further comprises an image sensor at one end thereof.

14. The optical image stabilizer as claimed in claim 10, further comprising a guide means for guiding the movements of the board in the first and the second directions, while preventing the board from rotating around an optical axis of the camera lens assembly.

15. The optical image stabilizer as claimed in claim 14, wherein the guide means includes:
a first slider fixed to the other surface of the board and having an opening extending in the first direction;
a first guide shaft extending in the first direction and slidably coupled to the opening of the first slider;
a pair of second sliders fixed to both ends of the first guide shaft, each having an opening extending in the second direction; and
a pair of second guide shafts extending in the second direction, each slidably coupled to the opening of the second slider.

16. The optical image stabilizer as claimed in claim 10, wherein the optical lens stabilizer is adaptable to a lens assembly having at least one lens.

17. The optical image stabilizer as claimed in claim 10, wherein the first direction is substantially perpendicular to the second direction.

18. The optical image stabilizer as claimed in claim 10, wherein the double actuator drives the board when a movement of the camera lens assembly is detected.
